(19) United States
(12) Patent Application Publication
(10) Pub. No.: US 2015/0313784 A1
(43) Pub. Date: Nov. 5, 2015

(54) Lower Lumber Traction Device and Method of Use

(71) Applicants: Joseph Wilbur Evans, Houston, TX (US); Robert Golden Gottlieb, Houston, TX (US)

(72) Inventors: Joseph Wilbur Evans, Houston, TX (US); Robert Golden Gottlieb, Houston, TX (US)

(21) Appl. No.: 14/696,560

(22) Filed: Apr. 27, 2015

Related U.S. Application Data
(60) Provisional application No. 61/986,508, filed on Apr. 30, 2014.
(60) Provisional application No. 62/089,671, filed on Dec. 9, 2014.

(51) Int. Cl. A61H 1/02

(52) U.S. Cl. CPC A61H 1/0222; A61H 1/0292

(57) ABSTRACT

A lower lumbar traction device for pulling and bending of the human spine with the hips suspended above the underlying surface. This device and method of use is a simple tool that when used properly may help those suffering from common forms of mechanically induced low back pain. The device and method of use uses gravity, leverage, and friction to produce decompressive forces directed at the most common location of discomfort, i.e., the posterior side of the lower lumbar vertebrae where bulging disc materials press against spinal nerves emerging from the spinal column as well as muscle stretching forces applied to lower and middle back area. The device comprises of: a width-adjustable and position-adjustable popliteal support mechanism; a popliteal support attachment mechanism; a truss with a plurality of slots; a hinge mechanism; a height-adjustable forward leg assembly with optional handles; a height-adjustable aft truss support mechanism; and a plurality of cables.

### CROSS-REFERENCE TO RELATED APPLICATIONS

This application claims priority to U.S. provisional patent application 61/986,508, filed Apr. 30, 2014, and U.S. provisional patent application 62/089,671, filed on Dec. 9, 2014, both of which are incorporated by reference herein in their entirety.

### STATEMENT REGARDING FEDERALLY SPONSORED RESEARCH

Not applicable

### BACKGROUND

The vertebral discs, i.e., the vertebral cushions between vertebrae, are made up of the outer fibrous part, the disc annulus, and the inner pulpous part, the nucleus pulposus. These materials act together to cushion the vertebrae against all types of static and dynamic compressive forces.

These disc materials are made of water and collagen of the human body. Collagen is the main structural protein of the various connective tissues in the human body. When compressive forces overwhelm this cushioning effect, water is slowly squeezed out and disc bulging occurs, eventually herniation can result. Medical research has shown that disc bulging and herniation of as little as 1.6 mm outward distance from its normal shape can result in lower back pain if the materials push a spinal nerve emerging from the spinal cord against the opposing facet bone. In most cases involving mechanically induced low back pain, low back pain is that simple. A solution is as simple as the problem. Simply force the disc materials back away from the spinal nerves using non-invasive mechanical techniques, i.e., stretching at the precise location in the obvious direction long enough to allow the body's natural healing mechanisms to restore the disc materials to their normal shape and function. How this is accomplished is discussed thoroughly in this application.

Facet bones are part of the spine that are knuckle shaped and allow for bending and twisting of the spine. The nucleus pulposus is the medical term for the gelatinous sac in the center or nucleus of the disc. It provides a short term cushioning or shock absorption effect during sudden vertical impacts or vibrations. The nucleus pulposus is made of collagen that has been hydrolyzed, i.e., water added. Without water, the cushioning effect is reduced. The disc annulus is the medical term for the outer material of the vertebral disc. It provides structural containment support for the inner material, the nucleus pulposus, as well as a cushioning effect for constant compressive forces along the spine.

Constant or even sudden overwhelming compressive forces created by improper spinal posture such as slouching to one side can lead to too much compressive force at a specific location on the disc. This can lead to a diminished cushioning effect of the disc annulus at that location. Over time, the harder disc annulus material flattens on one side and the structural integrity decreases. This allows the gelatinous sac to push its way out driven by the static and dynamic compressive forces applied along the spine. Over time, this in turn can lead to disc bulging and eventually disc herniation in a person.

According to recent issues of Consumer Reports, from March, 2013, 14,000 surveyed readers rated a number of lower back pain treatments that helped them with their back pain. See http://www.consumerreports.org/cro/2013/01/relief-for-your-aching-back/index.htm. In regards to this online article, many of the treatments required third-parties such as doctors, chiropractors, massage, and physical therapists to treat the pain. For many users these treatments may be too expensive and inconvenient and may require more time, money, and patience to receive treatment for the pain. 39% of the respondents surveyed in this article who tried spinal traction to relieve their low back pain, however, revealed that traction of the lower back was an effective method for pain relief. In many embodiments, the present invention makes it convenient and easy for a user to apply traction to their lower back at home in a bed at any time. They can even take it with them when the travel. Although the article warned low back pain sufferers that applying traction could result in even more pain that could even require surgery, this could be true for any type of low back pain treatment whether it is completely left alone or even administered by one's self or by a professional. This invention gives the low back pain sufferer the option to conveniently and comfortably treat themselves with a tool that they use and control to stretch their back. The pain professional could instruct the low back pain sufferer on its proper method of use, if they so choose.

In many embodiments of the present invention, the present invention may decompress the lower lumbar section of the human spine to temporarily eliminate lower back pain. In several embodiments, the present invention assists the user to sit up in a bed, or other reclining devices. This feature can be especially useful for those users who are paralyzed from the waist down.

As compared to the present inventive device, many other commercial traction devices, such as inversion tables, are expensive and take up too much space in the user's domicile, especially when not in use. They have to be designed to hold up the entire weight of the user. And since the user can hang upside-down, the structural integrity of the device should meet stringent safety standards which significantly increases the manufacturing costs. Just this fact alone eliminates millions of potential users who can't afford the cost and or risk of use. Inversion tables are not easily transported when the low back pain sufferer travels. Even some of the other traction devices in the prior art are not easily portable, or storable. Other traction devices can be heavy, difficult to operate and maintain, and warn the user that it is not safe around children. Other traction devices are mounted to components of the dwelling which could fail or become marred. Finally, inversion table devices can weigh significantly more than the present invention. Perhaps by a factor of 7. Inversion tables can also be accidentally tipped over, or positioned such that a user's limb can become pinched, or injured during operation or storage. Yet, people still buy and use them because the reward of being pain free outweighs the risk, cost, and inconvenience of use. Lowering the risk, cost, and inconvenience of use by eliminating any possibility of hanging by your feet by an elevated foot restraint increases the likelihood of significantly more low back pain sufferers to control their own pain at any time or place so they can return to normal activities faster, cheaper, and longer. The present inventive device overcomes these prior art deficiencies, and can provide additional benefits as well.

Devices that bend the lower back only or pull the lower back only with the same amount of force at that location produces a much weaker pressure gradient. Overwhelming pulling force along the spine such as that produced by hanging by your feet can produce the desired pressure gradient, however, since the spine is curved at the precise location of discomfort. Pulling on a curved structure produces tension and torsion at the precise location of discomfort. This is precisely why inversion tables are designed to hang the user by their feet in a bulky and restrictive machine. The problems introduced by hanging upside down however, increases health risks for many people as well as naturally scares many people who fear hanging by their feet. This invention eliminates the need to raise the body significantly and dangerously above the head from a horizontal position. It also eliminates any fear of hanging upside down as well as many health risks associated with hanging upside down because the head and shoulders are safely and comfortably resting on the underlying surface which in most cases is completely horizontal. Combining pulling and bending lessens the pulling force and the bending force needed produce the total force for the traction application compared to a pulling only traction application or a bending only traction application requiring the same total force. This method of force combination in a virtually horizontal body position can lower the weight and complexity of the device, which in turn significantly lowers the cost and increases the safety of using the device. This makes it more affordable and safer to use for even more low back pain sufferers. The lower back pain sufferers that can afford and safely use the device, the more people stop missing work and get back to work or other normal activities. Even though this device is not intended to effectively treat all low back pain sufferers experiencing all levels of low back pain due to any and all causes, it may help millions of people in some form or fashion because it may be more affordable, convenient, and safer to use than the more expensive spinal traction devices on the market today.

The convenience of using the present inventive device in/on a bed may also appeal to those who prefer not to lie down on the floor. Many elderly people do not feel comfortable lying on the floor since it is too difficult and sometimes painful in getting backup. They are, however, comfortable with lying on a bed since it is much easier to get back up on their feet. In several preferred embodiments, the present inventive device can be folded and quickly slid under a bed using just one hand. Our prior invention entitled “Self-operating back stretching device”, US 20140106941 A1 was difficult to quickly fold and slide under the bed. This feature is significant for users that require easy and quick storage close to their bed without giving up any performance.

U.S. Pat. No. 4,502,170 entitled “To improve posture/relieving lower back pain of a person in supine position” is a traction device consisting of a lower and upper pillow. The lower pillow is convex and preferentially supports the ilia, sacrum, and fifth lumbar vertebra, i.e., the hip area. Its purpose is to fully oppose any bending moment at the hips due to the weight of the abdomen pushing down on the lower lumbar section of the spine. The upper pillow supports the back of the thighs and calves at specific surface angles pointing either horizontal or downward while the user is in a supine position. According to the inventor, lower back pain may be relieved when these two pillows work together to support the hips and legs in a supine position. This device and method of use is quite different from the present invention which supports the legs and calves in a similar manner but not at the horizontal or downward surface angles. The present invention also requires the user's hips to be suspended above the surface without any pillows underneath the hips. In the present invention, the back pain relieving effect may be magnified when the user's shoulders are slowly inched along the underlying surface and away from the knee supports while the user is grasping and pushing on the handles. This increases tension in the spine and is completely user controlled. The unsupported hips in the present invention create a bending moment in the lower lumbar in the desired direction to further decompress the lower lumbar vertebrae on the posterior side more than the anterior side, thereby creating a pressure gradient in the body fluids surrounding the bulging disc materials physically pushing on exposed nerves emerging from the spinal column. The present invention uses the synergy of gentle pulling and bending of the lower lumbar to setup and instigate this pressure gradient application directly to the bulging disc material between the vertebrae to accelerate the body's natural disc restorative process. The present invention illuminates non-obvious elements that do not appear in the referenced invention which, by the way, was abandoned after the first renewal fee date expired.

U.S. Pat. No. 5,097,553 entitled “Leg support for relief of back pain” is a device that supports the back of the thighs, knees, calves, and feet while the user is in a supine position. The buttocks and back of the thighs are in contact with a supportive surface extending from the device's bottom and rises at an inclined angle until it meets the back of the calves. At that point the supportive surface curves to a horizontal top surface that extends long enough to support the user's leg between the knee and the foot. The present invention has no inclined surface in contact with the user's buttocks and back of the entire length of the thigh and then extend horizontally to support the calves and feet. Supporting the buttocks and the entire length of the back of the thigh would defeat the desired effect from the synergy of combining gentle pulling and bending at the precise location of discomfort. Therefore, the present invention illuminates non-obvious elements that do not appear in the referenced invention which, by the way, was abandoned after the third renewal fee date expired.

U.S. Pat. Application No. US 20120089183 A1 entitled “Spinal traction device” is a device that uses the weight of the legs draped over a pivoting platform to stretch the user's back. As the legs extend due to the supportive platform rotating down and away from the user by gravity force, the user is kept in place by rigid armpit supports attached to the bottom of the device. The drawings show that the user's buttocks and hip area are supported by the bottom of the device. This defeats the desired effect from the synergy of combining gentle pulling and bending at the precise location of discomfort. Therefore, the present invention illuminates non-obvious elements that do not appear in the referenced invention.

### SUMMARY

In several embodiments of the present invention, the present invention operates under several parameters.

In one embodiment of the present invention, the present invention may decompress the lower lumbar section of the human spine to temporarily eliminate lower back pain. In several embodiments of the present invention, the aforementioned problem is addressed by suspending the hips of the user above the underlying surface the user is laying on, such as a floor, while maintaining contact between the back of the shoulders of the user and the underlying surface of the present inventive device. By undertaking the aforementioned action, the result can be lower lumbar spinal decompression and lower back muscle stretching that is controlled by the user of the inventive device.

In several embodiments of the present invention, the device consists of two width-and-position-adjustable knee supports which the user nestles the back of their knees in (popliteal area) while lying down on a flat surface such as a bed, floor, or table. The height of the user's knees are statically supported by the device using a combination of gravitational support and shearing stress in the form of skin friction such that the bottom of the user's hips are raised just slightly above the underlying surface while the user's shoulders are in contact with the underlying surface and under tension also using a combination of gravitational support and shearing stress in the form of skin friction. This position produces the desired bending force created by the weight of the user's abdomen pushing their lower back towards the underlying surface that is combined with the tension force existing between the user's knees in contact with the device and the user's shoulders in contact with the underlying surface. The knee supports produce enough skin friction to keep the user's hips suspended just above the underlying surface. The user's shoulders produce enough skin friction with the underlying surface to keep the spine in tension while the user lies in it in a completely relaxed state.

The knee supports are attached to a horizontal truss that spans a little more than the approximate width of the typical range of user's body sizes. The truss is supported by two forward height-adjustable legs at either end of the truss and one height-adjustable leg that is hinged to the bottom center of the truss. Each forward leg has a handle for the user to intuitively grip and push on if they want to. Pushing on the handles increases the tension on the spine. Alternatively pushing on the handles one-hand-at-a-time creates a side-to-side-waddling-of-the-hips motion that feels good. The height-adjustable center leg is shaped like an upside-down letter “T”. At each end of the horizontal portion of the upside-down T bar leg, a chord or cable of sufficient length connects the opposing forward leg attachment point at the bottom of each forward leg. This allows the device to quickly fold or unfold into an approximate pyramid shape by simply rotating the center leg towards or away from the two forward legs until the chords or cable become taught.

In several embodiments of the present invention, adding more spinal tension is accomplished manually, by the user by grasping and then pushing on the handles on the forward legs of the inventive device which further straightens the user's body out while the user's legs and popliteal area remain supported by the device. The user is in complete non-restrictive control of the amount of pulling and bending on their spine at all times. To immediately release all pulling and bending pressures, the user simply straightens their legs in the non-restrictive knee supports. This allows the user's legs to comfortably slip along the knee supports and hips to slump to the underlying surface while already in a lying position. The user's legs end up straightened and pointing upward while supported by the device. The user can either crawl back up into the knee supports with their knees nestled in the knee supports and commence their stretch once again or they can egress completely out of the device.

In several embodiments of the present invention, the claimed invention may differ from what currently exists on the market. In several preferred embodiments of the present invention, the present invention is less expensive, lighter weight, easier, safer, more convenient to use, and simpler construction than other commercial traction devices.

Many other prior art traction type devices, such as inversion tables, simply provide a gravity-derived tension along the spinal column only; when the hips, buttocks, back, shoulders and head are supported equally. In the present invention, the hips and lower back are not supported during proper operation. This would defeat the synergy of combining gentle pulling and bending at the precise location of discomfort. They become supported instantly by the underlying surface, however, when the user chooses to straighten his/her legs during proper operation to either egress or relieve all pulling and bending pressure. In some other devices attempts are made to simply bend the lower lumbar spine by raising and then lowering the hips above the underlying surface as seen in U.S. Pat. No. 6,443,916, but these devices are tension-free requiring additional design complexity, inconvenience, and cost of manufacturing to overcompensate the fact that it does not produce tension in the spine. It does not even have handles that the user can push on to add more spinal tension. Still other prior art devices provide pulling and bending, such as The Back Bubble as seen at www.backpainrelief.com, however, they too require additional design complexity, inconvenience, and cost of manufacturing. It is a cushioned inner tube that hangs from a doorway. The user enters their body inside of the inner tube while standing with it nestled under their armpits. They then kneel down until the device supports their body weight. This creates a gentle pulling and bending of the lower back at the precise location of discomfort. The user can also lie on the floor with their legs and hip inside of the inner tube. This position is difficult to get into and out of. Its design requires it to hold the entire weight of the user suspended above the ground in order to produce the desired gentle pulling and bending at the precise location of discomfort. Its mounting bracket depends on the user having a supportive structure, usually the wood beams above a doorway which must not fail. This requirement adds to the cost and installation complexity, not to mention the liability if the structure and or the mounting bracket fails. Also, the door must be open in order to mount and use the device. This reduces privacy which lessons its convenience features. Hanging from your armpits in a cushioned inner tube device suspended from the ceiling or in a doorway is not as affordable, safe, comfortable, and convenient as lying safely in a bed with your legs propped up on a comfortable support watching TV or reading a book.

The present inventive device, in several embodiments, may assist in short term as well as long term solutions to common forms of mechanically induced low back pain by allowing the user to completely control the stretching of their lower back using gentle pulling and bending at the precise location of discomfort. In several embodiments, the present inventive device may allow the user to accomplish their long term back strengthening and posture improving goals pain free.

The present inventive device preferably performs its functions in a safe, comfortable, convenient, and affordable way. Today, low back pain sufferers can only choose medical intervention or alternative medical practices such as over the counter pain reducing drugs with undesirable side-effects, home remedies that often require knowledge and experience to work right, or third-party interventions (all of which have their pros and cons) to alleviate back pain and lumbar discomfort. With so many choices, they all may result in increased pain or require subsequent surgery. The important thing is to get rid of the pain as soon as practical so your focus can be turned to identifying and effectively treating the root cause of the recurring pain before it leads to a chronic stage that may require surgery. The present inventive device may provide many low back pain sufferers a new and affordable choice in their early treatment of common forms of mechanically induced low back pain, which could help millions of people's health and wellbeing.

In several embodiments of the present invention, the present invention comprises: a lower lumbar traction device comprising: a width-adjustable and position-adjustable popliteal support mechanism; said popliteal support mechanism further comprising a popliteal attachment support attachment mechanism; an upper truss with a plurality of horizontal slots; and a centered pivoting mechanism; said popliteal support is mechanically attached to said upper truss with a slot through said slot by said popliteal attachment support attachment mechanism; said upper truss with a slot is mechanically attached to said pivoting mechanism; an adjustable forward leg assembly; said adjustable leg assembly further comprising and upper forward leg element and a lower forward leg element with an optional handle; said upper forward leg element is connected and in mechanical communication with said lower forward leg element; said adjustable leg assembly is attached and in mechanical communication with said pivoting mechanism; an aft truss support mechanism; said aft truss support mechanism further comprising an adjustable aft leg assembly; a lower truss and a cable; said adjustable aft leg assembly is attached and in mechanical communication with said lower truss; said lower truss is attached and in mechanical communication with said cable; said cable is attached and in mechanical communication with said lower forward leg element.

In some embodiments, of the inventive device popliteal support comprises an inner face and side walls. In some embodiments of the inventive device the cable comprises multiple cables. In some embodiments of the inventive device the popliteal support can be widened and or repositioned relative to said slot. In some embodiments of the present inventive device, the present inventive device is used in conjunction with an underlying surface; wherein the lower truss, said cable and said lower forward leg element with handle are in communication with said underlying surface.

In some embodiments of the present inventive device, the present inventive device is a method for using a lower lumbar traction device comprising the steps of: unfolding a lower lumbar traction support device comprising: a popliteal support mechanism; said popliteal support mechanism further comprising a popliteal attachment support attachment mechanism; an upper truss with a plurality of slots; and a centered pivoting mechanism; said popliteal support is mechanically attached to said upper truss with a slot through said slot by said popliteal attachment support attachment mechanism; said upper truss with a plurality of slots is mechanically attached to said centered pivoting mechanism; an adjustable forward leg assembly; said adjustable leg assembly further comprising and upper forward leg element and a lower forward leg element with an optional handle; said upper forward leg element is connected and in mechanical communication with said lower forward leg element; said adjustable leg assembly is attached and in mechanical communication with said pivoting mechanism; an aft truss support mechanism; said aft truss support mechanism further comprising an adjustable aft leg assembly; a lower truss and a cable; said adjustable aft leg assembly is attached and in mechanical communication with said lower truss; said lower truss is attached and in mechanical communication with said cable; said cable is attached and in mechanical communication with said lower forward leg element; and placing said lower lumbar traction support device on an underlying surface sitting on said underlying surface while facing said aft support truss mechanism; grasping said adjustable forward leg assembly or the optional handles therein tilting it up; raising the user's legs up and placing the back side of the user's calves on said popliteal support; and lifting said users hips just above said underlying surface by crawling into and nestling the back of each knee in the popliteal support.

In some embodiments of the present invention the method further comprises the steps of: pushing the user's body away from said lower lumbar traction device by pushing horizontally on each forward leg assembly or the optional handles. In some embodiments of the present invention, the method further comprises the steps of: said surface further comprises a bed; entering into said bed; manipulating said user's legs to straddle said lower lumbar traction device at the foot of said bed; grasping the lower forward legs or the optional handles and lifting said lower forward legs while rotating said forward legs forward towards the user; placing the users elbows on the upper forward leg elements while grasping the upper truss; drawing the users forearms towards their shoulders.

In some embodiments of the present invention, the present invention is a method for assembling a lower lumbar traction device comprising: providing a width-adjustable and position-adjustable popliteal support mechanism; said popliteal support mechanism further comprising a popliteal attachment support attachment mechanism; an upper truss with a plurality of slots; and a pivoting mechanism; attaching mechanically said popliteal support to said upper truss with a slot through said slot by said popliteal attachment support attachment mechanism; attaching mechanically said upper truss with a slot to said pivoting mechanism; providing an adjustable forward leg assembly; said adjustable leg assembly further comprising and upper forward leg element and a lower forward leg element with an optional handle; connecting said upper forward leg element in mechanical communication with said lower forward leg element; attaching said adjustable leg assembly in mechanical communication with said pivoting mechanism; providing an aft truss support mechanism; said aft truss support mechanism further comprising an adjustable aft leg assembly; a lower truss and a cable; attaching said adjustable aft leg assembly in mechanical communication with said lower truss; attaching said lower truss in mechanical communication with said cable; attaching said cable in mechanical communication with said lower forward leg element. In some embodiments of the present invention the method further comprises repositioning said popliteal support relative to said slot. In some embodiments of the present invention the method further comprises; providing an underlying surface; wherein placing said lower truss, said cable and said lower forward leg element in communication with said underlying surface.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 illustrates one embodiment of the present invention in partial assembled ¾ view.

FIG. 2 illustrates one embodiment of the present invention in an exploded view.

FIG. 3 illustrates one embodiment of the present invention in partial side view with a user utilizing the invention.

FIG. 4 illustrates one embodiment of the present invention in partial assembled ¼ view.

### DETAILED DESCRIPTION

In the following description, certain details are set forth such as specific quantities, sizes, etc. . . . so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated in this specification or if the incorporation is necessary for maintaining validity.

In several embodiments of the present invention the present invention generally contains: a lower lumbar traction device; a popliteal support; a popliteal support attachment mechanism; and upper truss; and plurality of upper truss slots; adjustable forward leg assembly; upper forward leg element; lower forward leg element; pivoting mechanism; all truss support mechanism; adjustable aft leg assembly; lower truss, and a plurality of cables.

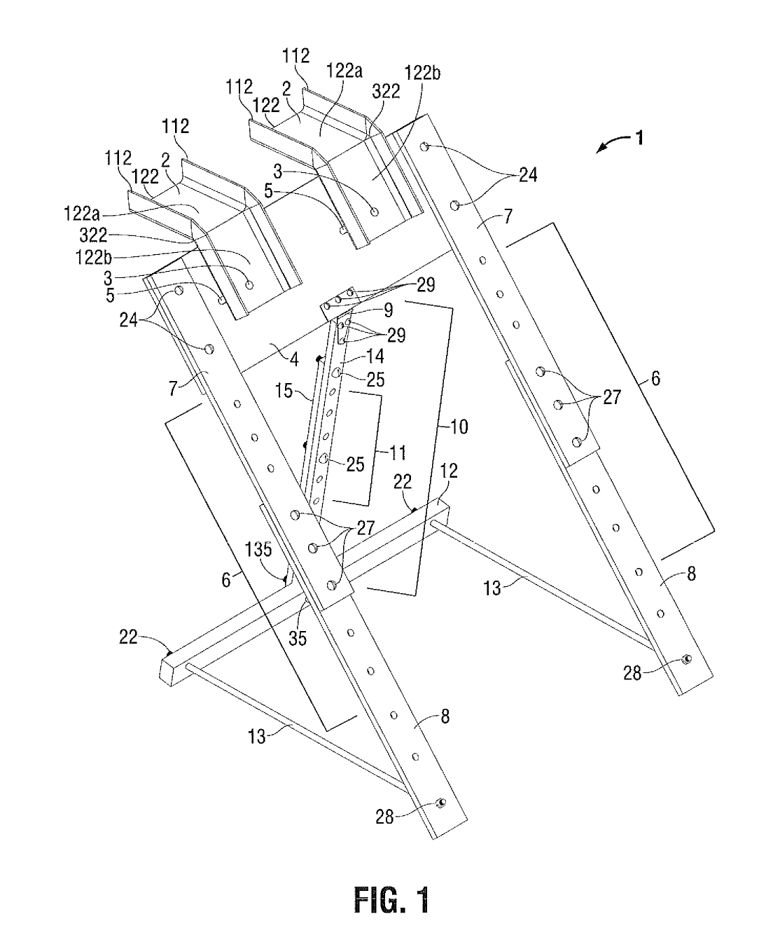

FIG. 1 illustrates one embodiment of the present invention in partial assembled ¾ view. In many embodiments of the present invention, the lower lumbar traction device 1, as a whole, may be constructed as a light weight and portable solution for traction type devices used to treat lower back pain which may contain, but are not limited to, lightweight plastics, metals, composites, and the like. Individual components of the lower lumbar traction device 1 may individually be composed of lightweight plastics, metals, composites, and the like, including some elements being composed of partially elastic and/or elastic cable.

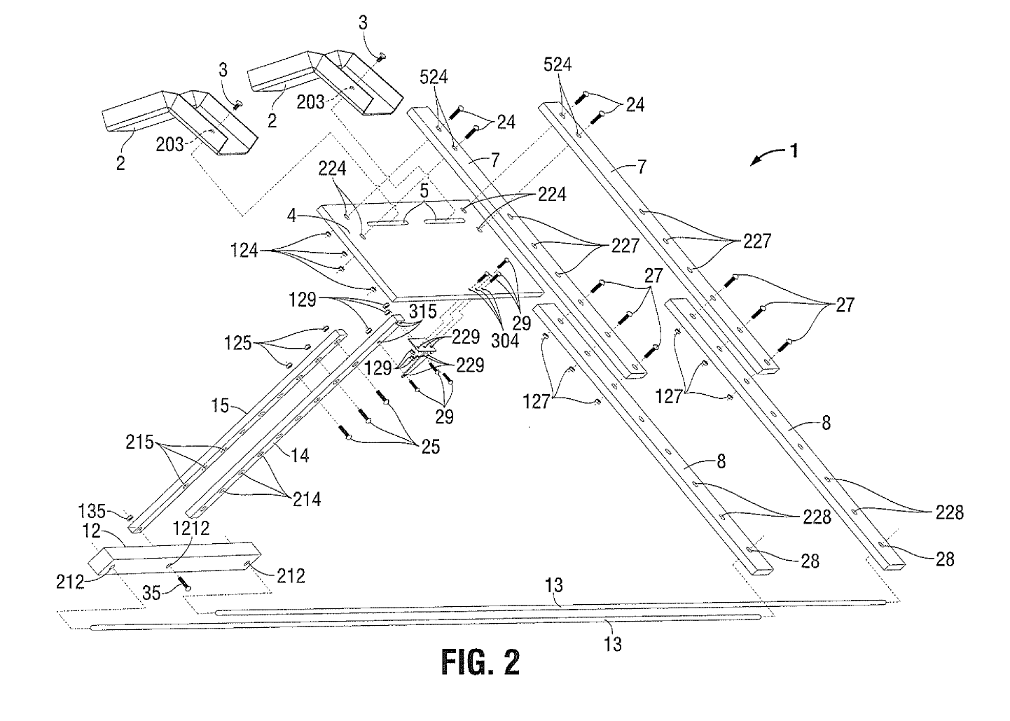

FIGS. 1 and 2 illustrate the popliteal supports 2. In several preferred embodiments of the present invention the popliteal supports are constructed with an inner face 122 and side walls 112. In several embodiments of the present invention, the popliteal supports 2 are constructed with an orifice(s) 203 on the inner face 122 (see FIG. 2). In many embodiments it is preferable that the side walls 112 are constructed parallel with each other and attached (in many embodiments perpendicular) to the inner face 122 of the popliteal support 2. In many embodiments of the present invention the popliteal support 2 can be constructed so that it is constructed bent at an angle 322 therein splitting the inner face 122 into two distinct sections upper face 122a and lower face 122b (See FIG. 1). There can be numerous popliteal supports 2 and they may be constructed to be identical, or form fitting for a left and/or right popliteal.

In several preferred embodiments of the present invention, the left and right popliteal supports 2 are mechanically attached to an upper truss 4, using a popliteal support attachment mechanism 3. In these embodiments, lower face 122b preferably is constructed with an orifice 203 preferably designed to engage the mechanism 3 in a manner known in the art. In several embodiments of the present invention, the mechanism 3 may be constructed as a nut and bolt assembly, or other mechanical attachment mechanism as is known in the art. The attachment of the popliteal supports 2 to the upper truss 4 is preferably conducted in a standard mechanical method known in the art through the upper truss slots 5 (FIG. 2). The upper truss slots 5 may be multiple slots or one long single slot in several embodiments of the present invention.

As also illustrated in FIGS. 1 and 2, in several preferred embodiments of the present invention, the present invention also contains an upper truss 4. The upper truss 4 is preferably constructed to have two slots 5 created in tandem on the upper truss 4 (although embodiments with only one slot may be constructed). When assembled, the popliteal supports 2 can be attached to the upper truss 4 via the use of the mechanism 3 being placed through the orifice 203 and then the slot 5 and mechanically secured. The upper truss 4 may be composed of lightweight plastics, metals, composites, and the like. Also illustrated, FIG. 2, upper truss 4 is preferable constructed with several lower orifices 304 designed to attach to a pivoting mechanism 9.

As also illustrated in FIGS. 1 and 2, in several embodiments of the present invention, there are two adjustable forward leg assemblies 6. The adjustable leg assemblies 6 can be comprised of the two substantial elements of, the upper forward leg element 7 and the lower forward leg element 8. The adjustable leg assembly 6 may be composed of lightweight plastics, metals, composites, and the like. The upper forward leg element 7 is preferable composed with several orifices 227 running through its body. The upper orifices 524 on forward leg element 7 are designed to attach with attachment mechanisms 24 to the upper truss 4, specifically at the orifices 224 located at both distal ends of the upper truss 4 through the use of attachment mechanisms 24 and 124. Attachment mechanisms 24 and 124 may be those commonly found in the art such as nuts and bolts.

The lower forward leg element 8 is preferable composed with several orifices 228 running through its body. The lower orifices 227 on upper forward leg element 7 are designed to align and engage with the corresponding orifices 228 on the lower forward leg element 8 through the attachment mechanisms 27 and 127. Attachment mechanisms 27 and 127 may be those commonly found in the art such as nuts and bolts. In several preferred embodiments of the present invention, both left and right adjustable forward leg assemblies 6, are comprised of the upper forward leg element 7, and the lower forward leg element 8. In preferred embodiments of the present invention upper forward leg element 7, is rigidly attached to the lower forward leg element 8 through the attachment mechanisms 27 and 127. In several other embodiments the attachment of upper forward leg element 7 and lower forward leg element 8 can vary dependents on the use of the attachment mechanisms 27 and 127 through various different orifices 228 on lower forward leg element 8 such that the overall length of the forward leg assembly 6 may vary.

In several of the embodiments of the present invention, the present invention utilizes an aft truss support 10. In many embodiments, the aft truss support 10 is mechanically attached to the upper truss 4 preferably utilizing the pivoting mechanism 9 that allows the aft truss support 10, to mechanically pivot about the lateral axis running substantially through the rotational center of the pivoting mechanism 9. The pivoting mechanism 9 can be constructed from a hinge, as is known in the art, and attached to the upper truss 4 via pins or bolts 229 as well as securing nuts 129 as is known in the art.

The aft truss support 10 is preferably comprised of the adjustable aft leg assembly 11 and the lower truss 12 which can extend downward towards the underlying surface 500 while in use. The adjustable aft leg assembly 11 maybe further comprised of the upper aft leg element 14 and lower aft leg element 15. The upper aft leg element 14 is preferably comprised with a body with numerous orifices 214 located throughout. The lower aft leg element 15 is preferably comprised with a body with numerous orifices 215 located throughout. In one preferred assembly, the orifices 214 and 215 are preferably aligned so that the lower aft leg element 15 and the upper after leg element 14 can be mechanically attached by putting attachment mechanisms such as bolts 25 and nuts 125 through the proper orifices 215 and 214. The use of varying orifices 214 and 215 can be varied by the user 1000 so as to adjust the net length of the adjustable aft leg assembly 11. As shown (FIG. 2) the upper aft leg element 14 maybe attached to the pivoting mechanism 9 through additional bolts 229 and nuts 129 through orifices 315 located on the upper aft leg element.

As shown in FIGS. 1 and 2, in several of the embodiments of the present invention, the present invention utilizes a lower truss 12. In many embodiments, lower truss 12 is preferably constructed with two distal orifices 212 and one medial orifice 1212. Orifice 1212 is preferably designed to aligned with the lowest orifice 215 on the lower aft leg element 15 such that the lower truss 12 and the lower aft leg element 15 can be mechanically attached by putting an attachment mechanism such as bolt 35 and nut 135 through the orifices 215 and 1212 and securing them.

In several embodiments of the present invention, there is a cable 13. Cable 13 can be looped through the orifices 212 and/or in alternate embodiments several cables 13 can be individually looped through the orifices 212 and then secured on the backside of the lower truss 12. The end of the cable(s) distal to the orifices 212 can then be secured through the lower orifices 28 on the lower forward leg element(s) 8.

In one embodiment of the present invention, one of the purposes of the design of the aft truss support mechanism 10 relates to the ease of use, convenience of use, cost, and safety of the overall lower lumbar traction device 1. In said embodiments, said aft truss support mechanism 10 design improvements can include, but are not limited to the following:

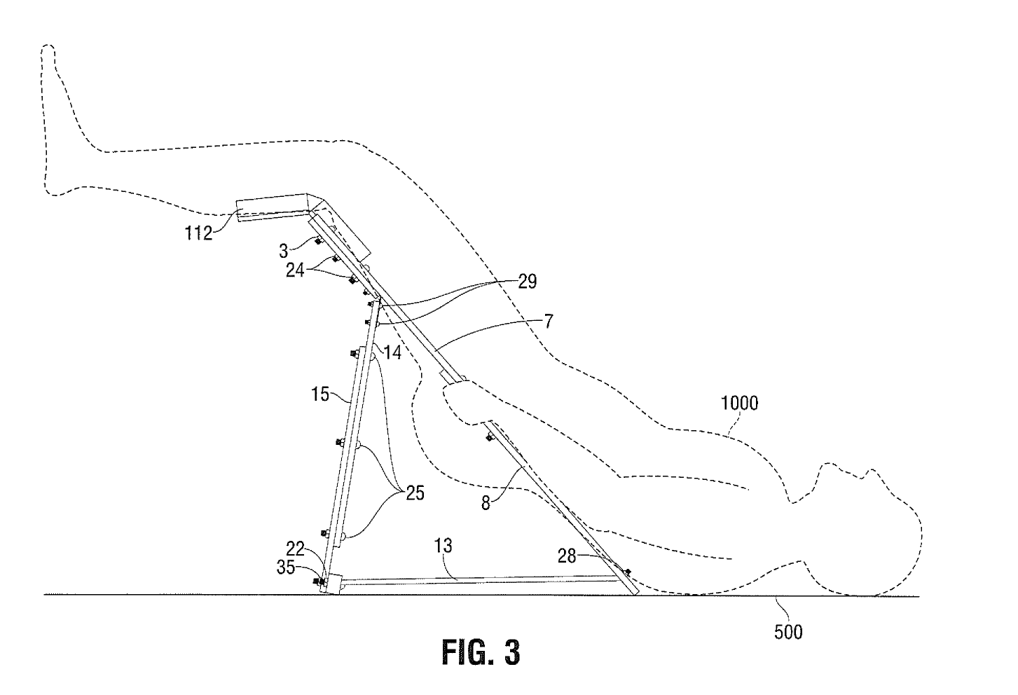

The present inventive device may ease of use in which the user 1000 (FIG. 3) may better position the lower lumbar traction device 1 using just one foot pushing on the aft truss support mechanism 10. Also, in several embodiments of the present invention, when collapsing the device 1 after use and while lying down, the user 1000 raises their knees and slides and rotates the device until it rests against their bottom, then gently rotates and folds the device 1 flat on the underlying surface 500. The folded lower lumbar traction device 1 can be pushed away with a user's 1000 feet or slid off the bed with their hands and leaned against the bed without having to sit up in bed.

In several embodiments of the present invention, the lower truss 12 minimizes the pressure exerted on the underlying surface 500, such as bed covers and sheets, which allow the user 1000 to use the device in bed. In several embodiments of the present invention the aft truss support mechanism 10 requires less building materials such as plastic, metals, composites, wood, hardware, paint, and labor than prior art devices utilizing two hinges and two adjustable legs. Having a centered hinged leg as opposed to two end hinged legs reduces the risk of pinching body parts and the time required to fold the device. In several embodiments of the present invention, the location of the pivoting mechanism 9 is at the midline from each adjustable forward leg assemblies 6 and limiting its range of rotation can be safer than locating a pivoting mechanism 9 directly behind each adjustable forward leg assemblies 6 because it eliminates the risk of pinching or injuring the user 1000 while folding the device flat. In several other embodiments of the present invention, the user 1000 may straddle the all truss support mechanism 10 to use the present inventive device 1 to assist user in sitting up in bed. Once straddled and in the process of sitting up, the user 1000 is locked in and prevented from rotating backward towards the bed, or surface 500.

In several embodiments of the present invention, the pivoting mechanism 9 is allowed to pivot along substantially the lateral axis until the aft truss support mechanism 10 comes in contact with each adjustable forward leg assemblies 6 or until the cable(s) 13 extend to their full length. In this embodiment, this safety feature eliminates the risk of pinching or injuring the user while folding the lower lumbar traction device 1 flat.

In several embodiments of the present invention, both the left and right cables 13, have two attachment locations 212. This limits the range of rotation of the aft truss support mechanism 10 and reduces the vertical pressure that the adjustable forward leg assemblies 6 exert on the underlying surface 500 made of bedding. The cables also act as a stable support in case an adjustable forward leg assembly 6 or the lower truss 12 slips off of the edge of a raised underlying surface 500 such as a bed or table. This support function significantly reduces the risk of a tipping incident.

FIG. 3 illustrates one embodiment of the present invention in partial side view with a user 1000 utilizing the present invention. In several embodiments of the present invention, the following is how the present inventive device may accomplish temporary relief of compressive forces on the lower lumbar spine and gently stretch the surrounding muscles and tendons. The skin friction between the user's 1000 shoulders in contact with the underlying surface oppose the skin friction between the user's 1000 popliteal area in contact with the popliteal supports 2. As the user 1000 pushes on the forward leg assemblies 6, this force relieves the skin friction forces exerted on the user's 1000 shoulders and opposes the skin friction between the user's 1000 popliteal area in contact with the popliteal supports 2. As this force increases, the legs of the user 1000 will eventually slip along the popliteal supports 2 until all spinal traction forces are reduced to zero and the user's 1000 body slumps to the underlying surface. For comfort and safety purposes, the user 1000 may straighten their legs to reduce all spinal traction forces to zero upon their choosing.

In several embodiments of the present invention, both the left and right popliteal supports 2 support the popliteal (back of knees) areas while in use. In several embodiments, the popliteal supports 2 are preferably designed to comfortably support the back of the knees without cutting off blood circulation or pinching nerves by maximizing the skin-to-surface area of the supports and eliminating pressure points on the popliteal veins, arteries, and nerves.

In many embodiments, the popliteal supports 2 are preferably designed to allow movement and orient themselves to the most comfortable and stable position for the user 1000 either before, during, or after use by the user 1000. Too much strain felt on the inside of the knee or knees may indicate that the popliteal supports 2 are too far apart and must be adjusted closer together across the upper truss slots 5. Too much strain felt on the outside of the knee or knees may indicate that the popliteal supports 2 are too close together and must be adjusted further apart across the upper truss slots 5. The popliteal supports 2 can be adjusted in position by loosening the attachment mechanism 3 sliding the popliteal supports 2 across the upper truss slots 5.

In several embodiments of the present invention, the user's 1000 knees remain in their respective popliteal supports 2 using friction between the user's skin and the inner face 122 of the popliteal support 2 or a combination of skin friction and slight leg muscle retraction. When the skin is dry, they tend to slip down and out of the popliteal supports 2. Moistening the skin with a proper ministrant may reduce slippage. In several embodiments of the present invention, the upper truss 4 may maintain support of approximately ⅓ of the user's weight and additional forces that the user applies to the lower lumbar traction device 1. The upper weight and height limit shall be designed to accommodate the 95^{th} percentile of adult male weights and heights which is about 255 lbs and 76″ tall. Since the user is not expected to apply their full weight on the present invention, the device shall be designed to hold an approximate weight of ⅓^{rd} of the maximum weighted user times a standard safety factor of ×2. This amount is approximately 170 lbs and is applied to one of the popliteal supports 2 since the user may alternate their weight from one leg to another while crawling into and out of the device. In several embodiments of the present invention, the upper truss 4 transmits vertical and horizontal dynamic and static forces from the user 1000, during operation, to both the left and right adjustable forward leg assemblies 6 and the aft truss support mechanism 10.

In some embodiments of the present invention, some horizontal forces are transmitted to both the left and right cables 13 (or through the entire cable 13 in embodiments with only one cable 13). On soft surfaces such as beds, the bottom of the forward leg assemblies 6 push heavily into the surface 500. This causes soft materials of the underlying surface 500 to push vertically on the cables 13. The surface of the cables 13 may resist these vertically distributed forces which reduces the pressure on the underlying surface 500 at the bottom of the forward leg assemblies 6. Without this design feature, in some embodiments of the present invention, the surface of the cables 13 would not help distribute the vertically distributed forces and raise the risk of bed sheet damage caused by excessive forces transmitted to the underlying surface 500 at the location of contact with the forward leg assemblies 6.

In some embodiments of the present invention, the vertical forces are transmitted to the underlying surface 500 through the three structural support assemblies, the forward leg assemblies 6 and the adjustable aft leg assembly attached to the upper truss 4 and the cables 13. In some embodiments of the present invention, the device's opposing shearing and compressive forces are statically transmitted to the user 1000 at the point of contact with the user's 1000 skin in the popliteal area. These shearing and compressive forces oppose gravity forces to direct the resulting gentle pulling and bending forces at the precise location of discomfort in the user's 1000 lower lumbar spine and lower back muscles. In some embodiments of the present invention, additional forces produced by the user 1000 pushing with their arms against the adjustable forward leg assemblies 6 with optional handles either simultaneously, or alternately, increases spinal tension as needed. The user 1000 controls the applied forces along the handles to stretch the user's 1000 back. The user 1000 may choose not to apply these additional forces and just relax while using the present inventive device 1.

In one embodiment of the present invention, it is preferable that all component parts need to be smooth, washable, stain and corrosion resistant, durable, scent free, and/or non-allergenic. In one embodiment of the invention, some aforementioned component pieces are cut, formed, and drilled to the design specifications prior to assembly. Some items may already exist in prior art, such as the pivoting mechanism 9 and attachment mechanisms, in the form of nut and bolt assemblies.

As shown, in part, in FIG. 3, in several embodiments of the present invention, the user 1000 may unfold the lower lumbar traction device 1 and stand it up on an underlying surface 500 such as a bed, couch, or floor. The user 1000 sits on the underlying surface 500 while facing the forward end of the device 1. The user 1000 may then lie in front of the adjustable forward leg assembles 6 with their knees up and feet flat on the underlying surface 500. The user 1000 may then grasp each adjustable forward leg assembly 6 with optional handles tilting it up, and raising the user's 1000 legs up, one-at-a-time, and placing the back side of the user's 1000 calves on the inner face 122 of the popliteal supports 2. The user 1000 may then position the device with their hands and anus while simultaneously using their legs one-at-a-time to move, or inch, their calves further up in the popliteal supports 2. This back-of-the-calf climbing method eventually lifts the user's 1000 hips just above the surface of the underlying surface 500; using the user's 1000 legs and positioning and orienting each leg on the popliteal supports 2 until each popliteal area is comfortably nestled into each popliteal support 2.

If needed, the user 1000 can, at any time, inch their shoulders horizontally along the underlying surface 500 and away from the portable popliteal support 2 while pushing horizontally on each adjustable forward leg assemblies 6 to increase the pulling tension that the device 1 imparts on the user's 1000 lower back and further raise the user's 1000 hips above the underlying surface 500. In several embodiments of the present invention, the user 1000 begins relaxing their back, hips, shoulders, neck, and legs to feel the onset of the gentle pulling and bending of their lower back. Should the user's legs begin slipping down, the user 1000 can use their legs muscles to apply more pressure on the popliteal supports 2 or utilize other methods to prevent slippage in the popliteal supports 2.

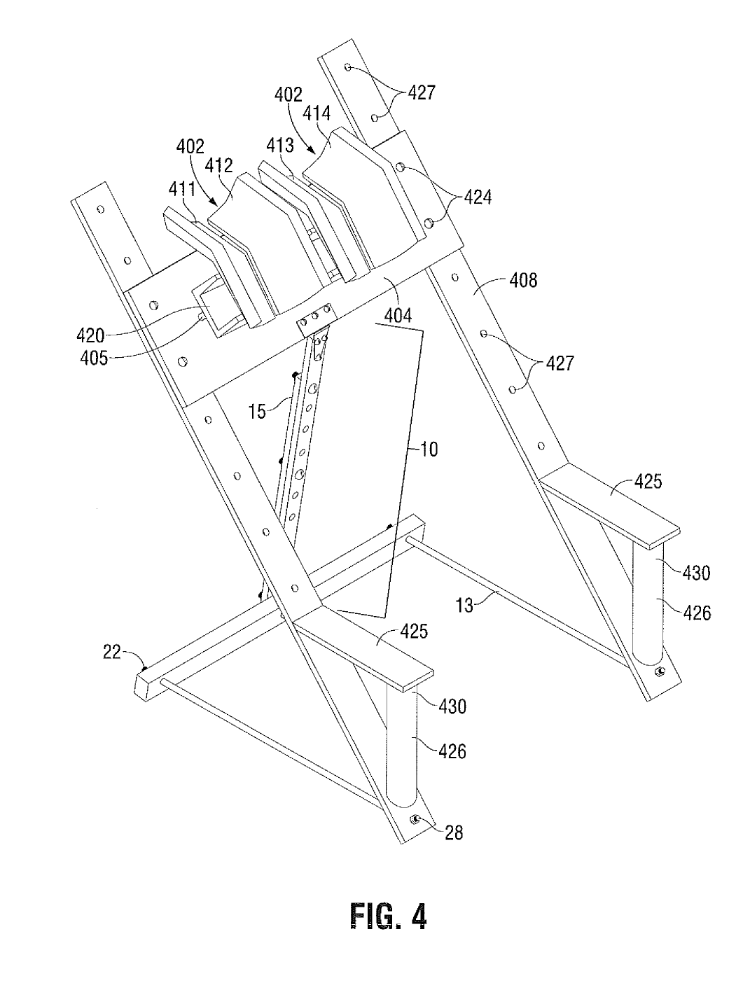

FIG. 4 illustrates one embodiment of the present invention in partial assembled ¾ view with some modification to the invention as illustrated in FIG. 1. In many embodiments of the present invention, the lower lumbar traction device 400, as a whole, may be constructed as a light weight and portable solution for traction type devices used to treat lower back pain which may contain, but are not limited to, lightweight plastics, metals, composites, and the like. Individual components of the lower lumbar traction device 400 may individually be composed of lightweight plastics, metals, composites, and the like, including some elements being composed of partially elastic and/or elastic cable.

FIG. 4 illustrates a modification (FIG. 1) of the popliteal supports 402. In several preferred embodiments of the present invention the popliteal supports are constructed with an inner faces 412 and 413 and side faces 411 and 414. In several embodiments of the present invention, the popliteal supports 402 are constructed with as two pieces for each support 402 such that the inner faces 412 and 413 can be moved distal or towards the outer faces 411 and 414 to adjust for a uses to accommodate different users leg widths. The popliteal supports 402 can also move laterally relative to each other about blocks 420 relative to the track 405 found on the upper truss 404. The blocks 420 may be attached to the upper truss 404 in a manner known in the art. In many embodiments it is preferable that the side walls 112 are constructed parallel with each other and attached (in many embodiments perpendicular) to the inner face 122 of the popliteal support 2. In several preferred embodiments of the present invention (FIG. 4), the left and right popliteal supports 402 are mechanically attached to an upper truss 404, in the manner as disclosed for FIG. 1.

As also illustrated in FIG. 4 in several preferred embodiments of the present invention, the present invention also contains an upper truss 404. The upper truss 404 is preferably constructed to have two slots 405 created in tandem on the upper truss 4 (although embodiments with only one slot may be constructed). The upper truss 404 may be composed of lightweight plastics, metals, composites, and the like. Also illustrated, FIG. 2, upper truss 404 is preferable constructed with several lower orifices 304 designed to attach to a pivoting mechanism 9.

As also illustrated in FIG. 4, in several embodiments of the present invention, as a variation of the invention illustrate in FIG. 1, there are two adjustable forward leg assemblies 408. The adjustable leg assembly 408 may be composed of lightweight plastics, metals, composites, and the like. The leg assemblies 408 is preferable composed with several orifices 427 running through their body. The upper truss 404, in this embodiment may be attached through the use of attachment mechanisms 424, as are known in the art to the leg assemblies 408 through the orifices 427. See also FIGS. 1 and 2.

As also illustrated in FIG. 4, in several embodiments of the present invention, as a variation of the invention illustrate in FIG. 1, there are two adjustable forward leg assemblies 408 with handle assemblies 430. The handle assemblies 430 may be composed of lightweight plastics, metals, composites, and the like. As illustrated the handle assemblies 430 are comprised of a top face 425 and a bottom pillar 432, although some in some embodiments the handle assemblies 430 can be precast as one unit, or even precast to be one unit with the forward leg assemblies 408.

As also illustrated in FIG. 4, in several embodiments of the present invention, as a variation of the invention illustrate in FIG. 1, the present invention can have the faces 411, 412, 413, and 414 move distal or towards each other to adjust for a typical range of user's leg size. The popliteal supports 402 can move distal or towards each other on the blocks 420 across the track 405. The upper truss 404 can be adjusted in position on the forward leg assembly 408. The two adjustable forward leg assemblies 408 with handle assemblies 430 are also illustrated. Use of the present invention, as per FIG. 4, is similar to that of FIG. 3, with the added option that a user can place their upper arms on the top face 425 of the handle assemblies 430 for comfort, or use the bottom pillars 432 to assist with entry into the invention during use, or for carrying purposes.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

We claim:

1. A lower lumbar traction device comprising:
a popliteal support mechanism;
said popliteal support mechanism further comprising a popliteal attachment support attachment mechanism; an upper truss with a slot; and a pivoting mechanism;
said popliteal support is mechanically attached to said upper truss with a slot through said slot by said popliteal attachment support attachment mechanism;
said upper truss with a slot is mechanically attached to said pivoting mechanism;
an adjustable forward leg assembly;
said adjustable leg assembly further comprising and upper forward leg element and a lower forward leg element;
said upper forward leg element is connected and in mechanical communication with said lower forward leg element;
said adjustable leg assembly is attached and in mechanical communication with said pivoting mechanism;
an aft truss support mechanism;
Said aft truss support mechanism further comprising an adjustable aft leg assembly; a lower truss and a cable;
said adjustable aft leg assembly is attached and in mechanical communication with said lower truss;
said lower truss is attached and in mechanical communication with said cable;
said cable is attached and in mechanical communication with said lower forward leg element.

2. The device of claim 1 further comprising:
Said popliteal support comprises an inner face and side walls.

3. The device of claim 1 further comprising:
Said popliteal support comprises width-adjustable inner face and side walls.

4. The device of claim 1 further comprising:
Said cable comprises multiple cables.

5. The device of claim 1 further comprising:
Said popliteal support can be repositioned relative to said slot.

6. The device of claim 1 further comprising:
An underlying surface; wherein
Said lower truss, said cable and said lower forward leg element are in communication with said underlying surface.

7. The device of claim 1 further comprising:
Said adjustable leg assembly further comprising a said lower forward leg element with a handle.

8. A method for using a lower lumbar traction device comprising the steps of:
Unfolding a lower lumbar traction support device comprising:
A popliteal support mechanism;
said popliteal support mechanism further comprising a popliteal attachment support attachment mechanism; an upper truss with a slot; and a pivoting mechanism;
said popliteal support is mechanically attached to said upper truss with a slot through said slot by said popliteal attachment support attachment mechanism;
said upper truss with a slot is mechanically attached to said pivoting mechanism;
an adjustable forward leg assembly;
said adjustable leg assembly further comprising and upper forward leg element and a lower forward leg element;
said upper forward leg element is connected and in mechanical communication with said lower forward leg element;
said adjustable leg assembly is attached and in mechanical communication with said pivoting mechanism;
an aft truss support mechanism;
Said aft truss support mechanism further comprising an adjustable aft leg assembly; a lower truss and a cable;
said adjustable aft leg assembly is attached and in mechanical communication with said lower truss;
said lower truss is attached and in mechanical communication with said cable;
said cable is attached and in mechanical communication with said lower forward leg element; and
Placing said lower lumbar traction support device on an underlying surface
Sitting on said underlying surface while facing said aft support truss mechanism;
Grasping said adjustable forward leg assembly therein tilting it up
Raising the users legs up and placing the back side of the user's calves on said popliteal support; and
Lifting said users hips just above said underlying surface by pressing the popliteal support.

9. The method of claim 8 further comprising the steps of:
Pushing the user's body away from said lower lumbar traction device by pushing horizontally on each forward leg assembly with or without optional handles.

10. The method of claim 8 further comprising the steps of
Said surface further comprises a bed;
Entering into said bed;
Manipulating said user's legs to straddle said lower lumbar traction device at the foot of said bed;
Grasping the lower forward legs and lifting said lower forward legs with optional handles while rotating said forward legs forward towards the user;
Placing the user's elbows on the upper forward leg elements while grasping the upper truss;
Drawing the user's forearms towards their shoulders.

11. A method for assembling a lower lumbar traction device comprising:
Providing a popliteal support mechanism;
said popliteal support mechanism further comprising a popliteal attachment support attachment mechanism; an upper truss with a plurality of slots; and a pivoting mechanism;
Attaching mechanically said popliteal support to said upper truss with a slot through said slot by said popliteal attachment support attachment mechanism;
Attaching mechanically said upper truss with a plurality of slots to said pivoting mechanism;
Providing an adjustable forward leg assembly;
said adjustable leg assembly further comprising and upper forward leg element and a lower forward leg element with optional handles;
Connecting said upper forward leg element in mechanical communication with said lower forward leg element;
Attaching said adjustable leg assembly in mechanical communication with said pivoting mechanism;
Providing an aft truss support mechanism;
Said aft truss support mechanism further comprising an adjustable aft leg assembly; a lower truss and a cable;
Attaching said adjustable aft leg assembly in mechanical communication with said lower truss;
Attaching said lower truss in mechanical communication with said cable;
Attaching said cable in mechanical communication with said lower forward leg element with optional handles.

12. The method of claim 11 further comprising:
Said popliteal support comprises an inner face and side walls.

13. The method of claim 11 further comprising:
Said cable comprises multiple cables.

14. The method of claim 11 further comprising:
Repositioning said popliteal support relative to said slot.

15. The method of claim 11 further comprising:
Providing an underlying surface; wherein
Placing said lower truss, said cable and said lower forward leg element in communication with said underlying surface.
